(19) United States
(12) Patent Application Publication
(10) Pub. No.: US 2018/0314961 A1
(43) Pub. Date: Nov. 1, 2018

(54) MULTIUSER CONTENT RECOMMENDATION

(71) Applicant: Altair Engineering, Inc., Troy, MI (US)

(72) Inventors: James R. Scapa, West Bloomfield, MI (US); Stephanie A. Scapa, San Mateo, CA (US)

(21) Appl. No.: 15/967,091

(22) Filed: Apr. 30, 2018

Related U.S. Application Data
(60) Provisional application No. 62/491,317, filed on Apr. 28, 2017.

(51) Int. Cl. G06N 5/04; H04L 29/08

(52) U.S. Cl. CPC G06N 5/04; H04L 67/18; H04L 67/22; H04L 67/306

(57) ABSTRACT

In an example method, a request message including a request for a multiuser content recommendation is received at a network device from a first user device over a communications network. The network device identifies at least a first user account and a second user account based on the request message. The first user account is associated with the first user device and the second user account is associated with a second user device. The network device identifies respective user information associated with the first and second user accounts. The network device identifies content for recommendation with respect to the first and second user accounts based on the respective user information. The network device transmits, over the communications network, a respective content message to the first user device and second user device. Each content message includes the identified content and instructions to display the content on the respective first user device or second user device.

### CROSS REFERENCE TO RELATED APPLICATIONS

This application claims priority to U.S. Provisional Application No. 62/491,317 filed Apr. 28, 2017, which is incorporated herein by reference in its entirety.

### TECHNICAL FIELD

The present disclosure relates to apparatuses and methods of accessing content, such as digital content, in an electronic computing and communication system.

### BACKGROUND

Digital content, including computer software, music, and video, is increasingly being distributed to users via computer networks, which opens the possibility for new modes of user interaction with the digital content. However, most user interactions, such as the evaluations of digital content, are of limited scope and do not engender any relationship beyond that of evaluating the digital content. Accordingly, it may be desirable to utilize user interaction for providing digital content recommendations to one or more users.

### SUMMARY

Disclosed herein are aspects, features, elements, implementations, and embodiments of multiuser content recommendation.

In an aspect, a method includes receiving, at a network device from a first user device over a communications network, a request message including a request for a multiuser content recommendation, and identifying, by the network device, at least a first user account and a second user account based on the request message. The first user account is associated with the first user device and the second user account is associated with a second user device. The method also includes identifying, by the network device, respective user information associated with the first and second user accounts, identifying, by the network device, content for recommendation with respect to the first and second user accounts based on the respective user information, and transmitting, by the network device over the communications network, a respective content message to the first user device and second user device. Each content message includes the identified content and instructions to display the content on the respective first user device or second user device.

Implementations of this aspect can include one or more of the following features.

In some implementations, identifying the first user account and the second user account can include identifying user accounts associated with user devices that are proximately located with respect to a first user device.

In some implementations, the user information can include content evaluation information provided by one or more users associated with the user information.

In some implementations, the content evaluation information can indicate at least one evaluation for a respective content object for use during a respective activity associated with the multiuser content recommendation.

In some implementations, identifying content for recommendation with respect to the first and second user accounts can include identifying a content object for recommendation based on one or more evaluations for the content object for use during the activity associated with the multiuser content recommendation.

In another aspect, a method includes receiving, at a network device via a communications network, a content request message indicating a multiuser context. The method also includes identifying, by the network device, first account information corresponding to a first account identified based on the multiuser context, identifying, by the network device, second account information corresponding to a second account identified based on the multiuser context, and identifying, by the network device, content based on a combination of the first account information and the second account information. The method also includes transmitting, by the network device via the communications network, a respective content response message indicating the content to a first user device associated with the first account and a second user device associated with the second account.

In some implementations, the first user device and the second user device can be communicatively coupled via the communications network.

In another aspect, a method includes receiving, by a network device over a communications network, a request for a multiuser content recommendation. The method also includes identifying, by the network device, an activity associated with the multiuser content recommendation, identifying, by the network device, user accounts associated with the multiuser content recommendation, identifying, by the network device, user information associated with users corresponding to respective user accounts, and identifying, by the network device, content for recommendation to users corresponding to the user accounts based on at least one of the user information and the activity associated with the multiuser content recommendation, The method also includes transmitting, by the network device over the communications network, one or more messages indicating the identified content to one or more client devices corresponding to the user accounts associated with the multiuser content recommendation.

Implementations of this aspect can include one or more of the following features.

In some implementations, identifying user accounts associated with the multiuser content recommendation can include identifying user accounts associated with client devices that are proximately located with respect to a client device associated with the request for the multiuser content recommendation.

In some implementations, the client devices and the client device associated with the request for the multiuser content recommendation can be communicatively coupled over the communications network.

In some implementations, the user information can include content evaluation information provided by a user associated with the user information.

In some implementations, the content evaluation information can indicate an evaluation for using a content object during the activity associated with the multiuser content recommendation.

In some implementations, identifying content for recommendation to users corresponding to the user accounts can include identifying a content object for recommendation to the users corresponding to the user accounts based on an evaluation for using the content object during the activity associated with the multiuser content recommendation.

In some implementations, identifying the activity associated with the multiuser content recommendation can include identifying an activity included with the request for the multiuser content recommendation.

In some implementations, identifying user accounts associated with the multiuser content recommendation can include identifying user accounts included with the request for the multiuser content recommendation.

In another aspect, a system includes one or more processors, and one or more non-transitory computer readable media storing instructions. The instructions, when executed by the one or more processors, cause the one or more processors to perform various operations. The operations include receiving, at a network device over a communications network, a request for a multiuser content recommendation. The request for the multiuser content recommendation includes an activity associated with the multiuser content recommendation. The operations also include identifying, by the network device, user accounts associated with the multiuser content recommendation, identifying, by the network device, user information associated with users corresponding to respective user accounts, and identifying, by the network device, content for recommendation to users corresponding to the user accounts based on at least one of the user information and the activity associated with the multiuser content recommendation. The operations also include transmitting, by the network device over the communications network, one or more messages indicating the identified content to one or more client devices corresponding to the user accounts associated with the multiuser content recommendation.

Implementations of this aspect can include one or more of the following features.

In some implementations, the operations can include identifying user accounts associated with client devices that are proximately located with respect to a client device associated with the request for the multiuser content recommendation.

In some implementations, the client devices and the client device associated with the request for the multiuser content recommendation can be communicatively coupled over the communications network.

In some implementations, the user information can include content evaluation information provided by a user associated with the user information.

In some implementations, the content evaluation information can indicate an evaluation for using a content object during the activity associated with the multiuser content recommendation.

In some implementations, the operations can include identifying a content object for recommendation to the users corresponding to the user accounts based on an evaluation for using the content object during the activity associated with the multiuser content recommendation.

Implementations of the subject matter described herein can provide one or more technical benefits. In some implementations, computer systems can exchange digital content more efficiently and effectively across a communications network. For instance, a computer system can automatically predict a user's preferences, identify digital content based on those predicted preferences (e.g., based on specific attributes of the digital content, evaluations of the digital content by other users, etc.), and automatically regulate access to the digital content by the user's device (e.g., using a computerized license management system). As the identified digital content is tailored to a particular user's preferences, the digital content is more likely to be relevant to the user. Thus, computer systems can more provide digital content in a more efficient manner. Further, as the user is presented with relevant digital content, the user is less likely to “skip” or “cancel” playback of particular digital content items (e.g., due to low relevance). Accordingly, the exchange of data between a content provider system and the user's device is made more efficient. Further, this improvement can be achieved through the execution of particular rules specific to computerized devices (e.g., based on the processing of computerized metadata with respect to content items), enabling systems to automatically perform particular tasks (e.g., identifying and transmitting selected content items for devices associated with one another and/or in proximity to one another) without human intervention.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which:

FIG. 1 is a diagram of an example of a computing and communication system for a multiuser content recommendation in accordance with embodiments of this disclosure.

FIG. 2 is a flow diagram of a method for a multiuser content recommendation in accordance with embodiments of this disclosure.

FIG. 3 is a flow diagram of a method for a multiuser content recommendation in accordance with embodiments of this disclosure.

### DETAILED DESCRIPTION

The prevalence of networking technology as a way to access content, including digital content, has facilitated user consumption of that content (e.g. music and video streaming services). Further, in addition to increasing the number of channels through which a user can access the content (e.g. wireless as well as wired, land based, networks) the ability of the user to interact with the digital content has been enhanced. One way to enhance user interaction with content is by providing the user with a way to associate one form of content (e.g. entertainment content like music or television programs) with another form of content (e.g. non-entertainment content such as a user rating of the entertainment content). Further, the user interaction can be used to recommend digital content to one or more users.

The disclosed technology provides an advantageous way of recommending digital content to multiple users, by identifying content objects suitable for recommendation to the multiple users based on information associated with the digital content provided by the multiple users.

The aspects, features, elements, and embodiments of methods, procedures, or algorithms disclosed herein, or any part or parts thereof, may be implemented in a computer program, software, or firmware incorporated in a non-transitory computer-readable storage medium for execution by a computer or processor, such as a special purpose computer or processor, and may be implemented as a computer program product, such as a computer program product accessible from a tangible computer-usable or computer-readable medium.

As used herein, the terminology “computer” or “device” includes any unit, or combination of units, capable of performing any method, or any portion or portions thereof, disclosed herein. Devices may further include mobile devices that may include user equipment, a wireless transmit/receive unit, a mobile station, a fixed or mobile subscriber unit, a pager, a cellular telephone, a personal digital assistant (PDA), a computer, or any other type of user device capable of operating in a mobile environment. Devices can also include devices such as Internet of Things (IoT) gateways, IoT edge devices, sensors, wearable devices (e.g, smart watches), and medically implanted devices.

As used herein, the terminology “processor” includes a single processor or multiple processors, such one or more special purpose processors, one or more digital signal processors, one or more microprocessors, one or more controllers, one or more microcontrollers, one or more Application Specific Integrated Circuits (ASICs), one or more Application Specific Standard Products (ASSPs); one or more Field Programmable Gate Arrays (FPGAs) circuits, any other type or combination of integrated circuits (ICs), one or more state machines, or any combination thereof.

As used herein, the terminology “memory” includes any computer-usable or computer-readable medium or device that can, for example, tangibly contain, store, communicate, or transport any signal or information for use by or in connection with any processor. Examples of computer-readable storage mediums may include one or more read only memories, one or more random access memories, one or more registers, one or more cache memories, one or more semiconductor memory devices, one or more magnetic media, such as internal hard disks and removable disks, one or more magneto-optical media, one or more optical media such as CD-ROM disks, and digital versatile disks (DVDs), or any combination thereof.

As used herein, the terminology “example”, “embodiment”, “implementation”, “aspect”, “feature”, or “element” indicate serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terminology “digital content” may include computer software programs, video games, music, movies, videos, or any other media that may be embodied in digital form, and which may be accessed, downloaded, input, or otherwise transferred to a computer or processor. Digital content may include digital data or digital files that may be processed by external application programs or may be executed by external software, hardware, or both. As used herein, the terminology “content” may include live content or fixed content. Fixed content may include any content that may be presented from a tangible storage medium, such as digital content. Live content may include any content that may be accessed substantially concurrently with the creation or generation of the content, such as the presentation of a movie in a movie theater, a concert, a sporting event, or any other live event.

As used herein, the terminology “event” may include any presentation, distribution, or display of content capable of concurrent, or nearly concurrent, access by multiple users. For example, an event may include a physical presentation, such a presentation at a movie theater, concert hall, park, venue, museum, or restaurant, or a virtual presentation, such as a broadcast over the Internet or a television broadcast.

As used herein, the terminology “access” or “accessing” may include presenting, downloading, executing, streaming, or otherwise interacting, or enabling interaction, with a digital content object or event. In some embodiments, digital content objects may be executed, stored, or both, at a provider location. In some embodiments, digital content objects may be stored locally on a customer network or customer device and the digital content objects may be executed or run on the customer network or device.

In some embodiments, a node based license may indicate that content is accessible by a unique device, such as a computer, a unique account, such as an account associated with an individual user, or a combination of a unique device and a unique account. In some embodiments, a network based license may indicate that content is accessible by one or more devices within a specified network. For example, a defined number of devices within the network may concurrently access the content. In some embodiments, a license, including a node based license or a network based license, may be associated with a unique content object or event, or with a suite of related content objects and events.

As used herein, the terminology “assigned units”, “price”, “licensing price” or variations thereof, may include an assigned number of licensing units that may be exchanged or redeemed to access a particular event or digital content object. As used herein, the terminology “licensed units” or “allocated units” may refer to a total number of units provided to a customer or customer group. As used herein, the terminology “checked out units”, “redeemed units”, or “exchanged units” may refer to assigned units charged to a customer for events or digital content being accessed. “Available units” may refer to a difference between licensed units and checked out units. In some embodiments, licensing units may be temporarily or permanently exchanged for access. Temporarily exchanged licensing units may be returned to the pool of available units associated with the customer upon termination or completion of content access. Returned units may be included in the available units allocated to the customer and may be redeemed for access to other events or digital content.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

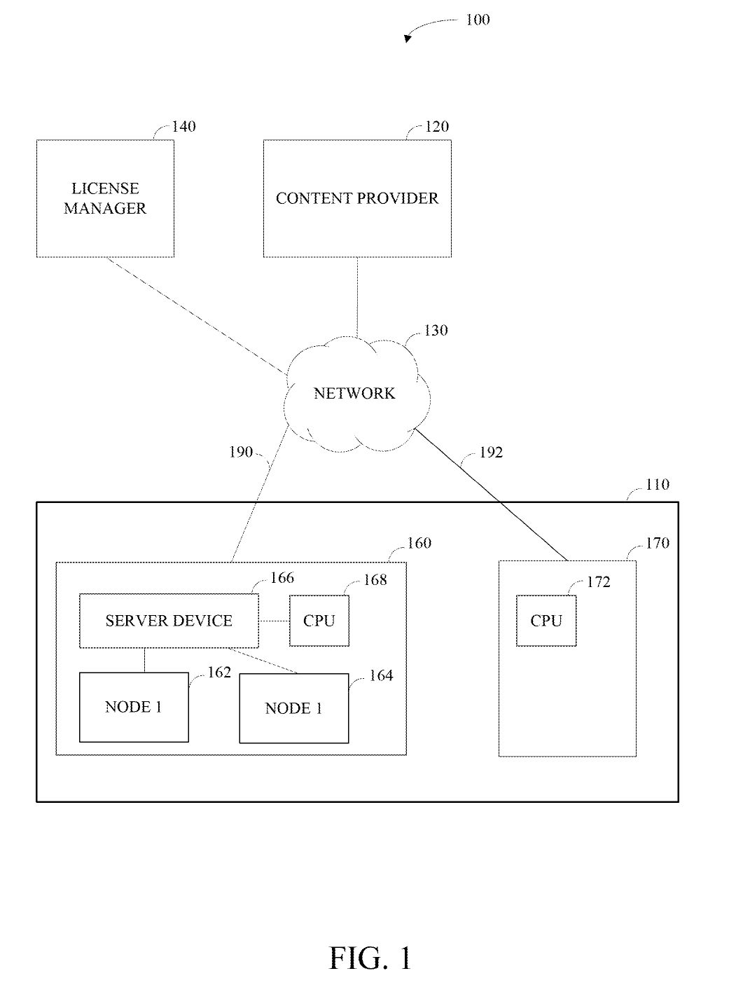

FIG. 1 is a diagram of an example of a computing and communication system 100 for multiuser content recommendation in accordance with embodiments of this disclosure. For simplicity, the computing and communication system 100 shown in FIG. 1 includes a customer system 110, a provider 120, a communication network 130, and a license manager 140; however, other elements, such as multiple networks, access points, or communication mediums may be included in a communication system for multiuser content recommendation.

In some embodiments, customer system 110 may be associated with an individual user or customer, and the user may access digital content or events using licensing units allocated to the user or to an account representing the user. In some embodiments, customer system 110 may comprise devices and networks through which a customer or user may access digital content from provider 120, or register for, or access, events. For example, as shown in FIG. 1, customer system 110 may include a customer network 160 and a client device 170; however, any number of customer networks and client devices may be used.

In some implementations, customer system 110 may be associated with a collection or group of customers, or members, and shared licensing units may be allocated to the group. For example, a group may include one or more families, a classroom of students, a small business, a social group, or any other organization capable of licensing digital content or events such that members of the group are capable of accessing the digital content or events.

In some embodiments, elements of the customer system 110, such as customer network 160 and client device 170, may communicate with each other or with elements external to the customer system 110, such as the provider 120. For example, customer network 160 and client device 170 may independently communicate through communication network 130.

In some embodiments, customer network 160 may include one or more individual nodes 162/164, a server device 166, a host processor 168, or any combination thereof. In some embodiments, the host processor 168 includes a central processing unit (CPU). A node 162/164 may be a device, such as a computer, and may access digital content. For example, a node 162/164 may access digital content in response to user input. Although FIG. 1 includes a first node 162 and a second node 164 for simplicity, any number of nodes may be used. In some embodiments, a node 162/164 may be connected to a server device 166 and may have a unique network address. In some embodiments, a node 162/164 may communicate with other nodes 162/164 within customer network 160. The server device 166 may communicate with host processor 168. Although individual nodes 162/164 are depicted as being connected in a spoke configuration to the server device 166, the individual nodes 162/164 may be connected in any other electronic computer network configuration. Although shown as separate units, in some embodiments, server device 166 and host processor 168 may be combined into a single device.

In some embodiments, client device 170 may be any device, such as a computer or mobile device, capable of accessing digital content. In some embodiments, a client device 170 may include a processor, such as CPU 172.

In some embodiments, provider 120 may be a device or system configured to provide access to digital content to one or more licensed customers. For example, provider 120 may include an Internet Protocol (IP) network-based unit, such as a website service, that implements methods for controlling access to digital content or events. In some embodiments, provider 120 may provide customer system 110 with access to digital content objects, which may be included in a suite of digital content. In some embodiments, provider 120 may be any system configured to control access to or registration for events by licensed customers. Although FIG. 1 shows the provider 120 as a single unit, the provider 120 may include any number of discrete units and any number of providers 120 may be used.

In some embodiments, the provider 120 may include an event provider (not shown separately) and may control access to or registration for one or more events. The event provider may be any system configured to receive a request to access or register for an event and output a response indicating whether access or registration is granted. In some embodiments, the request for access may include a request to register for the event, which may include receiving registration information. In some embodiments, the event provider may be the provider 120. In some embodiments, event provider may be separate from provider 120. Although shown as a single unit in FIG. 1, in some embodiments, the provider 120 may include a content provider as a first unit and the event provider as a second unit. For example, the content provider and the event provider may be independent units within a single physical device, or may be independent physical devices.

In some implementations, unit-based licensing for digital content may include communication between the customer system 110 and the provider 120 via the communication network 130. The communication network 130 may be a local area network (LAN), wide area network (WAN), virtual private network (VPN), a mobile or cellular telephone network, the Internet, or any other electronic communication medium. Although not explicitly shown in FIG. 1, each of the customer system 110, provider 120, and license manager 140 may communicate with communication network 130 through one or more Internet service providers (ISPs). In some embodiments, the customer network 160, the client device 170, or both, may communicate with the communication network 130 via a connection 190, a connection 192, or a combination of the connections 190/192, which may include one or more wired or wireless connections.

In some embodiments, a license manager 140 may be included in the computing and communication system 100. License manager 140 may control the access to digital content, provided by provider 120. Although shown as a separate unit, in some embodiments, license manager 140 may be incorporated with provider 120, customer system 110, or both. In some embodiments, the license manager 140 may monitor content access for the customer system 110. For example, the license manager 140 may detect the termination or conclusion of access to content.

In some embodiments, license manager 140 may generate and maintain a log. The log may include a record of a number of available units that may be used by the customer system 110 at any given time. In some embodiments, the license manager 140 may update the log for each change of the available units for customer system 110. For example, the log may be updated to indicate a change in the available units in response to the accessing digital content from provider 120, the termination of the access of digital content, or a change in pricing of digital content being accessed by the customer. In some embodiments, the log may be a file, or database, stored in a memory in communication with provider 120 or license manager 140.

Although not shown in FIG. 1, in some embodiments, the computing and communication system 100 may include a registration unit. In some embodiments, the registration unit may be a device, such as a computer. For example, the registration unit may be a kiosk physically located at an event location. In some embodiments, the registration unit may be configured to receive registration information. For example, the registration unit may include a user interface device, such as a keyboard or touchscreen, and may receive user input indicating registration information via the user input device. In some embodiments, the registration unit may communicate with a user device, such as client device 170.

In some embodiments, a multiuser content recommendation may include identifying content to be recommended to users associated with the multiuser content recommendation based on user information associated with the users.

Content items can be identified and transmitted in a manner that improves the functionality of computerized systems for storing, transmitting, and regulating access to digital content (e.g., one or more of the components, devices, or systems shown in FIG. 1). As an example, computer systems can automatically identify and exchange content items (e.g., playlists of digital content) based on a user's preferences. Content items can be automatically identified for a user, for instance, based on the specific attributes of the content items, the user's preferences, evaluations of the content items by other users, etc. Further, computer systems can automatically regulate access to specific content items by the user's device (e.g., using a computerized license management system). As the identified content items are tailored to a particular user's preferences, the content items are more likely to be relevant to the user. Thus, computer systems can more provide content items in a more efficient manner (e.g., by automatically identifying and providing personalized content, without manual intervention by a user). Further, as the user is presented with relevant content, the user is less likely to “skip” or “cancel” playback of particular content items (e.g., due to low relevance). Accordingly, the exchange of data between a content provider system and the user's device is made more efficient e.g., by reducing the likelihood of wasteful transmission of low-relevance content). Further, this improvement can be achieved through the execution of particular rules specific to computerized devices (e.g., based on the processing of computerized metadata with respect to content items), enabling systems to automatically perform particular tasks (e.g., identifying and transmitting selected content items for devices associated with one another and/or in proximity to one another) without human intervention.

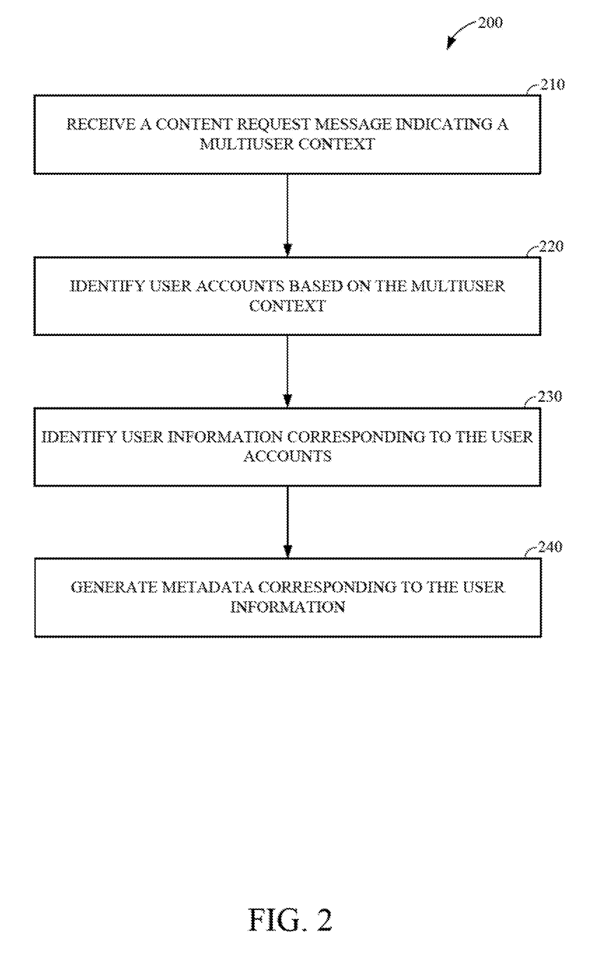

FIG. 2 is a flow diagram of a method for a multiuser content recommendation 200 in accordance with embodiments of this disclosure. A portion or the entirety of the process of the multiuser content recommendation 200 may be implemented by an apparatus that includes some or all of the features of at least one of: the client device 170 shown in FIG. 1; and the server device 166 shown in FIG. 1.

In some embodiments, the multiuser content recommendation 200 may include: receiving a content request message indicating a multiuser context 210; identifying user accounts based on the multiuser context 220; identifying user information corresponding to the user accounts 230; generating metadata corresponding to the user information 240; or a combination thereof.

At operation 210, a content request message indicating a multiuser context may be received. The multiuser context may include a request to generate a multiuser content recommendation. For example, the content request message may include a request to generate a multiuser content recommendation. The content request message indicating the multiuser context may be generated by, or otherwise associated with, a user or customer associated with, for example, the client device 170 of the customer system 110 as shown in FIG. 1 or any other suitable device. The request may be received locally or via a network, such as the communications network 130 shown in FIG. 1. The request to generate a multiuser content recommendation may include a request to recommend content, such as content described with respect to FIG. 1, to one or more users. The one or more users may include the user or customer associated with the client device 170 of the customer system 110 and may include one or more users associated with client devices associated with client systems that are remotely located with respect to the customer system 110. For example, the one or more users may include users or customers associated with respective client devices that are proximally located with respect to the client device 170. For example, the client devices may communicate with the customer system 100, the provider 120 (e.g., as shown in FIG. 1), other suitable systems or providers, or a combination thereof via the communications network 130, other suitable communications networks, or a combination thereof.

At operation 220, user accounts may be identified based on the multiuser context. In some embodiments, the request for a multiuser content recommendation may include defined, or otherwise specified, user accounts. For example, the user or customer associated with the client device 170 may include user account identifiers, such as, a unique user name, an account number, other suitable user account identifiers, or a combination thereof corresponding to user accounts associated with respective ones of the client devices with the request for a multiuser content recommendation. User accounts associated with the multiuser context may be identified by user account identifiers corresponding to the respective user accounts.

In some embodiments, user accounts associated with customer systems proximally located with respect to the customer system 110 may be identified as user accounts associated with the multiuser context. For example, a user account may be associated with a client device. The client device may be similar to or different from the client device 170. The client device and the client device 170 may communicate via the same WiFi network (e.g., the communications network 130). The user account associated with the client device may be identified as a user account associated with the multiuser context based on the client device communicating via the same network as the client device 170.

In some embodiments, a user account associated with a client device may be identified as a user account associated with the multiuser context (e.g., as request for a multiuser content recommendation) based on a determination that the client device is within a defined proximity relative to the client device 170. For example, the client device may communicate directly with the client device 170 via Bluetooth, near field communication, any other suitable wireless or wired connection, or a combination thereof. In some embodiments, user accounts associated with the multiuser context may be identified in other manners than those described herein.

In some embodiments, the user associated with the content request may include in the content request user account identifiers corresponding with user accounts associated with a multiuser content recommendation. The user accounts associated with the multiuser content recommendation may be identified based on the user account identifiers included in the content request.

At operation 230, user information corresponding to the user accounts may be identified. User information may include information associated with a user corresponding to a user account. The user information may include user profile information, such as, a user name, a user location, a user login status (e.g., indicating whether the user is logged in), other suitable profile information, or a combination thereof. The user information may include user usage information. User usage information may include statistical information such as how many times a user has consumed a particular content object, how many times a user has provided feedback on a particular content object, other suitable statistical information, or a combination thereof.

In some embodiments, the user information may include user content evaluation information. For example, a user associated with a user account may consume various content, such as, computer software programs, video games, music, movies, videos, or any other suitable content. The user may evaluate the content consumed by the user. For example, the user may provide user input via a user interface. The user input may indicate that the user likes or dislikes a particular content object. For example, the user may listen to a song provided by a content provider, such as the content provider described with respect to FIG. 1. The user may indicate, via the user interface, that the user likes the song.

In some embodiments, the user input may indicate a user's evaluation of content for use in one or more activities. For example, the user input may include evaluation information. The evaluation information may include a positive evaluation, a negative evaluation, or a scaled evaluation of a particular content object for use in one or more activities. The activities may include working, cleaning, cooking, driving, partying, relaxing, studying, exercising, or any other activity either defined or indicated by a user. For example, the evaluation information may indicate that a content object has an evaluation for use during a first activity. For example, the evaluation information may indicate that a song has a positive evaluation for use during an exercising activity. The evaluation information may indicate that a content object has a first evaluation for use during a first activity and a second evaluation for use in a second activity. For example, the evaluation information may indicate that a song has a positive evaluation for use during an exercising activity and a negative evaluation for use during a relaxing activity. The evaluation information may indicate any content object having any evaluation (e.g., positive, negative, or scaled) for one or more activities.

At operation 240, metadata corresponding to the user information may be generated. For example, metadata may be generated that corresponds to: profile information associated corresponding to user accounts associated with the multiuser context; content usage information corresponding to user accounts; content evaluations corresponding to a use of content objects in one or more activities; other suitable metadata corresponding to user information; or a combination thereof.

The metadata may include metadata that may represent a correlation of user information. For example, metadata corresponding to content evaluations may represent the evaluations (e.g., provided by users corresponding to the user accounts associated with the multiuser content recommendation) for a using a content object in an activity. For example, the metadata may represent the number of users (e.g., associated with the multiuser content recommendation) that indicated a positive evaluation for a song for use during an exercise activity. In some embodiments, the metadata may be stored. For example, the metadata may be stored on a network, such as on a storage device on the communications network 130, on a client device, such as on the client device 170, other suitable storage media, or a combination thereof.

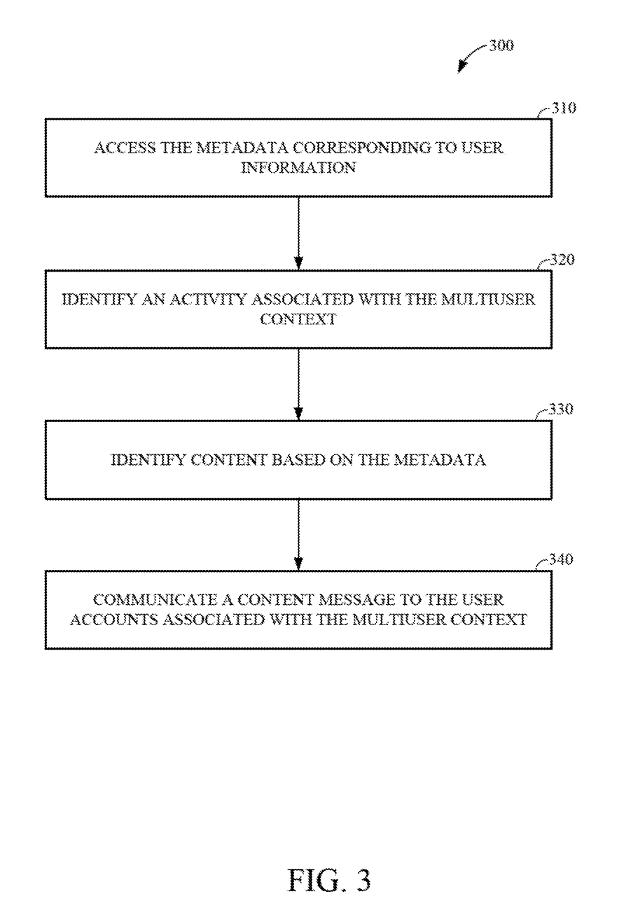

FIG. 3 is a flow diagram of a method for a multiuser content recommendation 300 in accordance with embodiments of this disclosure. A portion or the entirety of the process of the multiuser content recommendation 300 may be implemented by an apparatus that includes some or all of the features of at least one of: the client device 170 shown in FIG. 1; and the server device 166 shown in FIG. 1.

In some embodiments, the multiuser content recommendation 300 may include: accessing the metadata corresponding to the user information 310; identifying an activity associated with the multiuser context 320; identifying content based on the metadata 330; communicating a content message to the user accounts associated with the multiuser context 340; or a combination thereof.

At operation 310, metadata corresponding to user information may be accessed. For example, as described with respect to FIG. 2, the metadata may be stored on a network, such as on a storage device on the communications network 130, on a client device, such as on the client device 170, other suitable storage media, or a combination thereof.

At operation 320, an activity associated with the multiuser context may be identified. For example, the multiuser context may include a request for a multiuser content recommendation. One or more activities may be associated with the request for the multiuser content recommendation. An activity associated with the request for the multiuser content recommendation may indicate an activity that the users corresponding to the user accounts mendation may engage in. In some embodiments, a requesting user (e.g., the content request) may include an activity indicator in the request for a multiuser content recommendation. For example, the requesting user may indicate that the activity associated with the multiuser content recommendation is exercising.

In some embodiments, an activity associated with the request for a multiuser content recommendation may be identified based on: a location of one or more client devices associated with user accounts associated with the multiuser content recommendation; user input received from the user associated with the client device 170, user input received from one or more users associated with respective client devices, on a combination thereof; other suitable user input or user information; or a combination thereof. In some embodiments, identifying an activity associated with the multiuser context may be omitted.

At operation 330, content may be identified based on the metadata. As described above, metadata corresponding to identified user information may be generated and stored. In some embodiments, the multiuser context associated with the content request may include a request to generate a multiuser content recommendation. The multiuser content recommendation may include content suitable for recommendation to users associated with the multiuser context. Identifying content for the multiuser content recommendation may include identifying content to be used during the activity associated with the multiuser context, content having a positive review by one or more of the users associated with the multiuser context, other suitable content identifiable based on the metadata, or a combination thereof. For example, the metadata may include metadata that represents a correlation of user information corresponding to the user accounts associated with the multiuser context. The metadata may indicate that a percentage of the users associated with the user accounts indicated a positive evaluation for using a content object for an activity.

In some embodiments, content for recommendation to the user accounts associated with the multiuser context may be identified based on whether the percent of users that indicated a positive evaluation for using a content object during the activity associated with the multiuser content recommendation is greater than a threshold. For example, the metadata may indicate that 60 percent of the users associated with the user accounts indicated a positive evaluation for using a first song during an exercising activity (e.g., the activity associated with the multiuser content recommendation). The first song may be identified for recommendation to the user accounts associated with the multiuser context if 60% is greater than the threshold.

In some embodiments, content for recommendation to the user accounts associated with a multiuser content recommendation may be identified based on whether the percent of users that indicated a positive evaluation for a content object (e.g., for example, during an activity) is greater than a positive threshold and whether the percent of users that indicated a negative evaluation for the content object (e.g., for example, during the activity) is less than a negative threshold. For example, the metadata may indicate that 60% of the users associated with the user accounts indicated a positive evaluation for a first song and 10% of the users associated with the user accounts indicated a negative evaluation for the first song. The first song may be identified for recommendation to the user accounts if 60% is greater than the positive threshold and 10% is less than the negative threshold.

In some embodiments, the metadata may include metadata that represents a weighted value associated with a content object. The weighted value may correspond to the number of users associated with the user accounts that indicated a positive evaluation for a content object. A first content object having a greater weight value than a second content object may indicate that more users indicated a positive evaluation for the content object. For example, the first content object may have a greater weight value than a second content object for use during a first activity. For example, the metadata may indicate that 60% of the users indicated a positive evaluation for using a first song for an exercising activity and 10% of the users indicated a positive evaluation for a using a second song during an exercising activity.

In some embodiments, the metadata may include user information associated with one or more user accounts. For example, the metadata may include user information associated with a first user account and user information associated with a second user account. The user information associated with the first user account may indicate content evaluation information that a first user associated with the first user account provided and the user information associated with the second user account may indicate content evaluation information that a second user associated with the second user account provided. Content may be identified based on the user information associated with the first user account, user information associated with the second user account, or a combination thereof.

In some embodiments, content for recommendation to the user accounts associated with the multiuser context may be identified based any other manner than those described herein.

At operation 340, a content message may be transmitted to the user accounts associated with the context. The content message may include a content recommendation. The content recommendation may indicate a recommendation of the content identified at operation 330. The content recommendation may be provided, transmitted, or otherwise communicated to client devices associated with respective user accounts. The users may consume the recommended content via the client devices associated with the respective user accounts. In some cases, the content recommendation can include a playlist identifying a sequence of multiple different items of content (e.g., multiple different recommended items of content). In some cases, the content recommendation can also include one or more items of content (e.g., one or more recommended items of content).

In some embodiments, users corresponding to the user accounts associated with the multiuser content recommendation may provide feedback associated with the content recommendation. For example, a user may provide user input that indicates positive feedback associated with the content recommendation, the user may provide user input that indicates negative feedback associated with the content recommendation, the user may provide user input that indicates any other feedback associated with the content recommendation, or a combination thereof. The feedback provided by the users corresponding to the user accounts may be stored, as described above. In some embodiments, content for recommendation to the user accounts based on the metadata may be identified (e.g., at operation 330) based on the metadata generated at operation 240 of FIG. 2, the feedback provided by users corresponding to the user accounts associated with the multiuser content recommendation, or a combination thereof.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method comprising:
receiving, at a network device from a first user device over a communications network, a request message including a request for a multiuser content recommendation;
identifying, by the network device, at least a first user account and a second user account based on the request message, wherein the first user account is associated with the first user device and the second user account is associated with a second user device;
identifying, by the network device, respective user information associated with the first and second user accounts;
identifying, by the network device, content for recommendation with respect to the first and second user accounts based on the respective user information;
transmitting, by the network device over the communications network, a respective content message to the first user device and second user device, each content message comprising the identified content and instructions to display the content on the respective first user device or second user device.

2. The method of claim 1, wherein identifying the first user account and the second user account includes identifying user accounts associated with user devices that are proximately located with respect to a first user device.

3. The method of claim 1, wherein the user information includes content evaluation information provided by one or more users associated with the user information.

4. The method of claim 3, wherein the content evaluation information indicates at least one evaluation for a respective content object for use during a respective activity associated with the multiuser content recommendation.

5. The method of claim 4, wherein identifying content for recommendation with respect to the first and second user accounts includes identifying a content object for recommendation based on one or more evaluations for the content object for use during the activity associated with the multiuser content recommendation.

6. A method comprising:
receiving, at a network device via a communications network, a content request message indicating a multiuser context;
identifying, by the network device, first account information corresponding to a first account identified based on the multiuser context;
identifying, by the network device, second account information corresponding to a second account identified based on the multiuser context;
identifying, by the network device, content based on a combination of the first account information and the second account information; and
transmitting, by the network device via the communications network, a respective content response message indicating the content to a first user device associated with the first account and a second user device associated with the second account.

7. The method of claim 2, wherein the first user device and the second user device are communicatively coupled via the communications network.

8. A method comprising:
receiving, by a network device over a communications network, a request for a multiuser content recommendation;
identifying, by the network device, an activity associated with the multiuser content recommendation;
identifying, by the network device, user accounts associated with the multiuser content recommendation;
identifying, by the network device, user information associated with users corresponding to respective user accounts;
identifying, by the network device, content for recommendation to users corresponding to the user accounts based on at least one of the user information and the activity associated with the multiuser content recommendation; and
transmitting, by the network device over the communications network, one or more messages indicating the identified content to one or more client devices corresponding to the user accounts associated with the multiuser content recommendation.

9. The method of claim 8, wherein identifying user accounts associated with the multiuser content recommendation includes identifying user accounts associated with client devices that are proximately located with respect to a client device associated with the request for the multiuser content recommendation.

10. The method of claim 9, wherein the client devices and the client device associated with the request for the multiuser content recommendation are communicatively coupled over the communications network.

11. The method of claim 8, wherein the user information includes content evaluation information provided by a user associated with the user information.

12. The method of claim 11, wherein the content evaluation information indicates an evaluation for using a content object during the activity associated with the multiuser content recommendation.

13. The method of claim 12, wherein identifying content for recommendation to users corresponding to the user accounts includes identifying a content object for recommendation to the users corresponding to the user accounts based on an evaluation for using the content object during the activity associated with the multiuser content recommendation.

14. The method of claim 8, wherein identifying the activity associated with the multiuser content recommendation includes identifying an activity included with the request for the multiuser content recommendation.

15. The method of claim 8, wherein identifying user accounts associated with the multiuser content recommendation includes identifying user accounts included with the request for the multiuser content recommendation.

16. A system comprising:
one or more processors; and
one or more non-transitory computer readable media storing instructions that, when executed by the one or more processors, cause the one or more processors to perform operations comprising:
receiving, at a network device over a communications network, a request for a multiuser content recommendation, wherein the request for the multiuser content recommendation includes an activity associated with the multiuser content recommendation;
identifying, by the network device, user accounts associated with the multiuser content recommendation;
identifying, by the network device, user information associated with users corresponding to respective user accounts;
identifying, by the network device, content for recommendation to users corresponding to the user accounts based on at least one of the user information and the activity associated with the multiuser content recommendation; and
transmitting, by the network device over the communications network, one or more messages indicating the identified content to one or more client devices corresponding to the user accounts associated with the multiuser content recommendation.

17. The system of claim 16, the operations comprising identifying user accounts associated with client devices that are proximately located with respect to a client device associated with the request for the multiuser content recommendation.

18. The system of claim 17, wherein the client devices and the client device associated with the request for the multiuser content recommendation are communicatively coupled over the communications network.

19. The system of claim 16, wherein the user information includes content evaluation information provided by a user associated with the user information.

20. The system of claim 19, wherein the content evaluation information indicates an evaluation for using a content object during the activity associated with the multiuser content recommendation.

21. The system of claim 20, the operations comprising identifying a content object for recommendation to the users corresponding to the user accounts based on an evaluation for using the content object during the activity associated with the multiuser content recommendation.
